(19) United States
(12) Patent Application Publication
(10) Pub. No.: US 2003/0211802 A1
(43) Pub. Date: Nov. 13, 2003

(54) Three-dimensional coform nonwoven web

(75) Inventors: Laura Elizabeth Keck, Alpharetta, GA (US); Charlene Bendu Harris, Snellville, GA (US); Nina Frazier, Marietta, GA (US)

Correspondence Address: KIMBERLY-CLARK WORLDWIDE, INC., 401 NORTH LAKE STREET, NEENAH, WI, 54956

(73) Assignee: Kimberly-Clark Worldwide, Inc.

(21) Appl. No.: 10/314,720

(22) Filed: Dec. 9, 2002

Related U.S. Application Data
(60) Provisional application No. 60/379,664, filed on May 10, 2002.

(51) Int. Cl. D04H 3/00; A47L 13/17; D04H 1/56; D04H 13/00; A47L 23/04; A47L 13/10; B08B 1/00

(52) U.S. Cl. 442/400; 15/104.93; 15/104.94; 15/228; 15/209.1; 15/208; 134/6; 442/327

(57) ABSTRACT

A tufted coform nonwoven web prepared from meltblown filaments and at least one secondary material is disclosed. The tufted coform nonwoven web is useful as cleaning pads, wipes, mops, among other articles of manufacture. One surface of the tufted coform nonwoven web has projections which increase the bulk of the nonwoven web. The projections also aid in the scrubbing and cleaning ability of the coform nonwoven web. Also disclosed is the process of producing the tufted coform nonwoven web, method of using the tufted coform nonwoven web as a wipe, mop, and the like, along with cleaning kits containing the coform nonwoven web.

This application claims priority from U.S. Provisional Application No. 60/379,664, filed May 10, 2002.

### FIELD OF THE INVENTION

The present invention relates to a coform nonwoven web, prepared from thermoplastic filaments and at least one secondary material, having a three-dimensional textured structure with outward projections (called “tufts”) from the surface of the nonwoven web. The three-dimensional coform nonwoven web is useful as cleaning pads, wipes, mops, among other articles of manufacture. The present invention also relates to the process of producing the three-dimensional textured coform nonwoven web, the method of using the three dimensional textured coform nonwoven web as a wipe, mop, scrubbing pads and the like, along with cleaning kits containing the three dimensional textured coform nonwoven web.

### BACKGROUND OF THE INVENTION

Coform nonwoven webs or coform materials are known in the art and have been used in a wide variety of applications, including wipes. The term “coform material” means a composite material containing a mixture or stabilized matrix of thermoplastic filaments and at least one additional material, often called the “second material” or “secondary material”. Examples of the second material include, for example, absorbent fibrous organic materials such as woody and non-wood pulp from, for example, cotton, rayon, recycled paper, pulp fluff; superabsorbent materials such as superabsorbent particles and fibers; inorganic absorbent materials and treated polymeric staple fibers, and other materials such as non-absorbent staple fibers and non-absorbent particles and the like. Exemplary coform materials are disclosed in commonly assigned U.S. Pat. No. 5,350,624 to Georger et al.; U.S. Pat. No. 4,100,324 to Anderson et al.; U.S. Pat. No. 4,469,734 to Minto; and U.S. Pat. No. 4,818,464 to Lau et al.

Nonwoven webs with projections or tufts are known in the art. For example, commonly assigned U.S. Pat. No. 4,741,941 to Engelbert et al. discloses a nonwoven web with hollow projections which extend outward from the surface of the nonwoven web. The projections can be made by a number of processes, but are preferably formed by directly forming the nonwoven web on a surface with corresponding projections, or by forming the nonwoven on an apertured surface with a pressure differential sufficient to draw the fibers through the apertures, thereby forming the projections. In the '941 patent, the outer surface of the resulting nonwoven web does not contain a mixture of thermoplastic filaments and a secondary material, such as in a coform nonwoven web. However, subsequent layers of the tufted nonwoven web described in the '941 patent may contain an absorbent material.

Nonwoven webs with projections have also been prepared by bonding a portion of the nonwoven and leaving a portion of the nonwoven unbonded using a compaction roll. This is described in commonly assigned U.S. Pat. No. 5,962,112 to Haynes et al. The bond pattern in the '112 patent is often referred to as a “pattern unbonded”, “point unbonded” or simply “PUB”. The nonwoven fabric having a PUB bond pattern has a continuous bond area defining a plurality of discrete unbonded areas. The fibers or filaments within the discrete unbonded areas are dimensionally stabilized by the continuous bond area that encircle or surround each unbonded area, such that no support or backing layer of film or adhesive is required. In contrast to the nonwoven web of the '112 patent, the projections or tufts of the nonwoven web of the present invention do not contain bonds formed by a compaction roll between the projections or tufts. That is, the projections or tufts of the present invention do not have a continuous bonded region between the individual projections or tufts.

Coform nonwoven webs have been used in applications such as disposable absorbent articles, absorbent dry wipes, wet wipes, wet mops and absorbent dry mops. However, the prior coform materials did not have tufts, wherein the tufts comprise a mixture of a thermoplastic polymer and a secondary material.

### SUMMARY OF THE INVENTION

The present invention relates to a three-dimensional tufted coform nonwoven web containing a matrix of thermoplastic meltblown filaments and at least one secondary material. The coform nonwoven web has a first exterior surface having raised portions called tufts, each tuft containing the matrix of the thermoplastic meltblown filaments and the at least one secondary material.

The present invention also relates to a process of producing the tufted coform nonwoven web. The process includes

a. providing at least one stream containing meltblown filaments;

b. providing at least one stream containing at least one secondary material;

c. converging the at least one stream containing at least one secondary material with the at least one stream of meltblown filaments to form a composite stream;

d. depositing the composite stream onto a shaped forming surface as a matrix of meltblown filaments and at least one secondary material to form a first deposited layer;

e. optionally applying a pressure differential to the matrix while on the forming surface; and

f. separating the nonwoven web from the shaped forming surface, wherein the nonwoven web contains an array of projections and land areas corresponding to the shaped forming surface.

Additional layers may be applied to the first layer by adding the additional steps of

d1. providing a second stream of meltblown filaments

d2. introducing a stream at least one secondary material to the second stream of meltblown filaments to form a second composite stream;

d3. depositing the second composite stream onto the deposited layer as a matrix of meltblown filaments and a secondary material to for a two layer tufted coform nonwoven web.

The tufted coform nonwoven webs and laminates of the present invention are useful as dry wipes, absorbent wipes, pre-moistened wipes, dry mops, absorbent mops, pre-moistened mops, among other absorbent articles of manufacture.

The present invention also relates to a cleaning implement comprising a handle; a head; and a removable cleaning sheet; wherein the head is connected to the handle and the removable cleaning sheet is removably attached to the head. The cleaning sheet is prepared from the tufted coform nonwoven web described above.

A further aspect of the present invention relates a method of cleaning a surface by contacting and wiping the surface with the tufted coform nonwoven web of the present invention.

The present invention also relates to a kit containing the cleaning implement of the present invention and a plurality of wipes or mops of the present invention.

In another aspect of the present invention, a stack of individual tufted coform nonwoven webs which are pre-moistened is also provided. The stack of webs can be used as wipes or mops and can be removed from a container holding the stack of the material one or more at a time.

### BRIEF DESCRIPTION OF THE DRAWINGS

FIG. 1 is a cross-section of a three dimensional or tufted coform nonwoven web of the present invention.

FIG. 2A is a simplified illustration of a forming surface that can be used in the process of FIG. 3 or FIG. 4, in one aspect of the present invention.

FIG. 2B shows a cross-section taken along line 2B-2B in FIG. 2A.

FIG. 3 illustrates a process which can be used to prepare a tufted coform nonwoven web of the present invention.

FIG. 4 illustrates a second process which may be used to prepare a tufted coform nonwoven web of the present invention.

FIG. 5 illustrates a cleaning implement of the present invention.

FIG. 6A shows a topographical micrograph of the structure of a nonwoven web of the present invention.

FIG. 6B shows a cross-section micrograph of a nonwoven web of the present invention.

### DEFINITIONS

As used herein, the term “comprising” is inclusive or open-ended and does not exclude additional unrecited elements, compositional components, or method steps.

As used herein, the term “fiber” includes both staple fibers, i.e., fibers which have a defined length between about 19 mm and about 60 mm, fibers longer than staple fiber but are not continuous, and continuous fibers, which are sometimes called “substantially continuous filaments” or simply “filaments”. The method in which the fiber is prepared will determine if the fiber is a staple fiber or a continuous filament.

As used herein, the term “nonwoven web” means a web having a structure of individual fibers or threads which are interlaid, but not in an identifiable manner as in a knitted web. Nonwoven webs have been formed from many processes, such as, for example, meltblowing processes, spunbonding processes, air-laying processes, coforming processes and bonded carded web processes. The basis weight of nonwoven webs is usually expressed in ounces of material per square yard (osy) or grams per square meter (gsm) and the fiber diameters useful are usually expressed in microns, or in the case of staple fibers, denier. It is noted that to convert from osy to gsm, multiply osy by 33.91.

As used herein, the term “meltblown fibers” means fibers formed by extruding a molten thermoplastic material through a plurality of fine, usually circular, die capillaries as molten threads or filaments into converging high velocity, usually hot, gas (e.g. air) streams which attenuate the filaments of molten thermoplastic material to reduce their diameter, which may be to microfiber diameter. Thereafter, the meltblown fibers are carried by the high velocity gas stream and are deposited on a collecting surface to form a web of randomly dispersed meltblown fibers. Such a process is disclosed, for example, in U.S. Pat. No. 3,849,241 to Butin, which is hereby incorporated by reference in its entirety. Meltblown fibers are microfibers, which may be continuous or discontinuous, and are generally smaller than 10 microns in average diameter. The term “meltblown” is also intended to cover other processes in which a high velocity gas (generally air) is used to aid in the formation of the filaments, such as melt spraying or centrifugal spinning.

As used herein, the term “coform nonwoven web” or “coform material” means composite materials comprising a mixture or stabilized matrix of thermoplastic filaments and at least one additional material, usually called the “second material” or the “secondary material”. As an example, coform materials may be made by a process in which at least one meltblown die head is arranged near a chute through which the second material is added to the web while it is forming. The second material may be, for example, an absorbent material such as fibrous organic materials such as woody and non-wood pulp such as cotton, rayon, recycled paper, pulp fluff; superabsorbent materials such as superabsorbent particles and fibers; inorganic absorbent materials and treated polymeric staple fibers and the like; or a non-absorbent material, such as non-absorbent staple fibers or non-absorbent particles. Exemplary coform materials are disclosed in commonly assigned U.S. Pat. No. 5,350,624 to Georger et al.; U.S. Pat. No. 4,100,324 to Anderson et al.; and U.S. Pat. No. 4,818,464 to Lau et al.; the entire contents of each is hereby incorporated by reference.

As used herein the term “spunbond fibers” refers to small diameter fibers of molecularly oriented polymeric material. Spunbond fibers may be formed by extruding molten thermoplastic material as filaments from a plurality of fine, usually circular capillaries of a spinneret with the diameter of the extruded filaments then being rapidly reduced as in, for example, U.S. Pat. No.4,340,563 to Appel et al., and U.S. Pat. No. 3,692,618 to Dorschner et al., U.S. Pat. No. 3,802,817 to Matsuki et al., U.S. Pat. Nos. 3,338,992 and 3,341,394 to Kinney, U.S. Pat. No. 3,502,763 to Hartman, U.S. Pat. No. 3,542,615 to Dobo et al, and U.S. Pat. No. 5,382,400 to Pike et al. Spunbond fibers are generally not tacky when they are deposited onto a collecting surface and are generally continuous. Spunbond fibers are often about 10 microns or greater in diameter. However, fine fiber spunbond webs (having and average fiber diameter less than about 10 microns) may be achieved by various methods including, but not limited to, those described in commonly assigned U.S. Pat. No. 6,200,669 to Marmon et al. and U.S. Pat. No. 5,759,926 to Pike et al.

As used herein, the term “polymer” generally includes, but is not limited to, homopolymers, copolymers, such as for example, block, graft, random and alternating copolymers, terpolymers, etc. and blends and modifications thereof. Furthermore, unless otherwise specifically limited, the term “polymer” shall include all possible geometrical configurations of the molecule. These configurations include, but are not limited to isotactic, syndiotactic and random symmetries.

As used herein, the term “multicomponent fibers” refers to fibers or filaments which have been formed from at least two polymers extruded from separate extruders but spun together to form one fiber. Multicomponent fibers are also sometimes referred to as “conjugate” or “bicomponent” fibers or filaments. The term “bicomponent” means that there are two polymeric components making up the fibers. The polymers are usually different from each other, although conjugate fibers may be prepared from the same polymer, if the polymer in each component is different from one another in some physical property, such as, for example, melting point or the softening point. In all cases, the polymers are arranged in substantially constantly positioned distinct zones across the cross-section of the multicomponent fibers or filaments and extend continuously along the length of the multicomponent fibers or filaments. The configuration of such a multicomponent fiber may be, for example, a sheath/core arrangement, wherein one polymer is surrounded by another, a side-by-side arrangement, a pie arrangement or an “islands-in-the-sea” arrangement. Multicomponent fibers are taught in U.S. Pat. No. 5,108,820 to Kaneko et al.; U.S. Pat. No. 5,336,552 to Strack et al.; and U.S. Pat. No. 5,382,400 to Pike et al.; the entire content of each is incorporated herein by reference. For two component fibers or filaments, the polymers may be present in ratios of 75/25, 50/50, 25/75 or any other desired ratios.

As used herein, the term “multiconstituent fibers” refers to fibers which have been formed from at least two polymers extruded from the same extruder as a blend or mixture. Multiconstituent fibers do not have the various polymer components arranged in relatively constantly positioned distinct zones across the cross-sectional area of the fiber and the various polymers are usually not continuous along the entire length of the fiber, instead usually forming fibrils or protofibrils which start and end at random. Fibers of this general type are discussed in, for example, U.S. Pat. Nos. 5,108,827 and 5,294,482 to Gessner.

As used herein, the phrase “fine meltblown filaments” is intended to represent meltblown filaments having an average fiber diameter less than about 15 microns.

As used herein, the phrase “coarse meltblown filaments” is intended to represent meltblown filaments having an average fiber diameter greater than about 15 microns.

As used herein, the term “tuft” or “tufted” is intended to mean projections extending out of the base plane of the nonwoven web. The projections may or may not be hollow on the opposite side of the nonwoven web, depending on the process conditions used to make the nonwoven web. Between each of the projections, there are areas that do not project out of the base plane. These areas are called “lands”. The fiber orientation in the tufts is different from the lands.

As used herein, the term “base plane” means the plane along the top of the valleys on the side of the nonwoven web with the protrusions. If both sides of the nonwoven web have protrusions, then the base plane is the plane at the central location of the nonwoven web without the protrusions.

As used herein, the term “abrasive” is intended to represent a surface texture which enables the nonwoven web to scour a surface being wiped or cleaned with the nonwoven web and remove dirt and the like. The abrasiveness can vary depending on the polymer used to prepare the abrasive fibers and the degree of texture of the nonwoven web.

As used herein, the term “non-abrasive” is intended to represent a surface texture which relatively soft and generally does not have the ability to scour a surface being wiped or cleaned with the nonwoven web.

As used herein, the term “pattern bonded” refers to a process of bonding a nonwoven web in a pattern by the application of heat and pressure or other methods, such as ultrasonic bonding. Thermal pattern bonding typically is carried out at a temperature in a range of from about 80° C. to about 180° C. and a pressure in a range of from about 150 to about 1,000 pounds per linear inch (59-178 kg/cm). The pattern employed typically will have from about 10 to about 250 bonds/inch² (1-40 bonds/cm²) covering from about 5 to about 30 percent of the surface area. Such pattern bonding is accomplished in accordance with known procedures. See, for example, U.S. Design Pat. No. 239,566 to Vogt, U.S. Design Pat. No. 264,512 to Rogers, U.S. Pat. No. 3,855,046 to Hansen et al., and U.S. Pat. No. 4,493,868 to Meitner et al. and U.S. Pat. No. 5,858,515 to Stokes et al., for illustrations of bonding patterns and a discussion of bonding procedures, which patents are incorporated herein by reference. Ultrasonic bonding is performed, for example, by passing the multilayer nonwoven web laminate between a sonic horn and anvil roll as illustrated in U.S. Pat. No. 4,374,888 to Bornslaeger, which is hereby incorporated by reference in its entirety.

### DETAILED DESCRIPTION

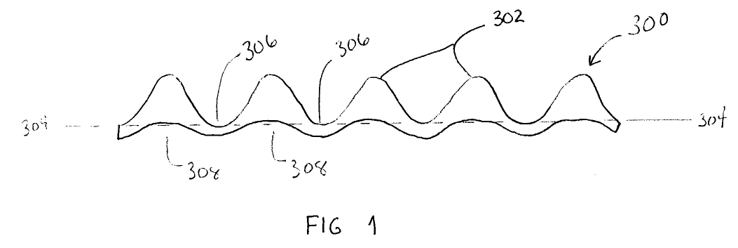

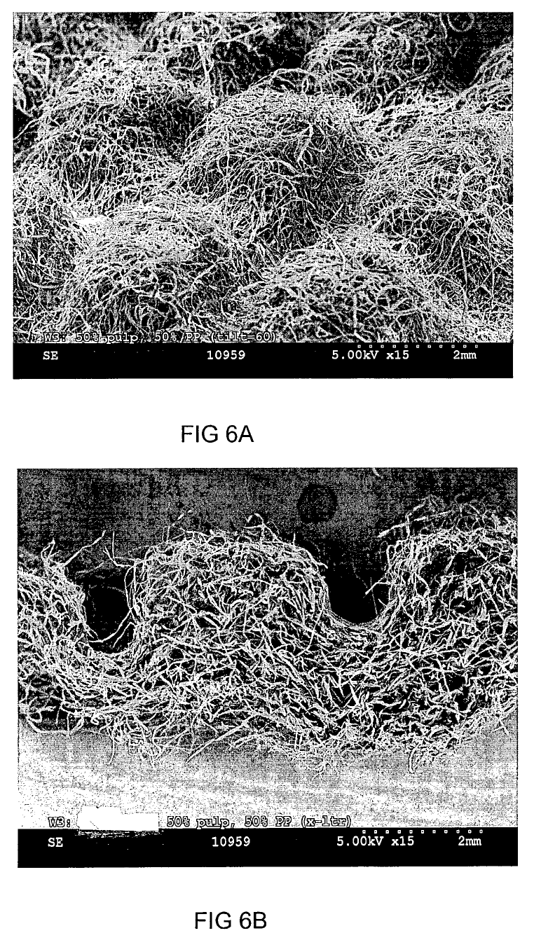

In order to provide a better understanding of the present invention, attention is directed to FIG. 1. The nonwoven web 300, has raised protrusions 302, which are also called “tufts”. Each tuft 302 is above the base plane 304 which is located at the upper surface of the lands 306. Depending on the process conditions used, the side of the nonwoven web opposite the side with the tufts may be hollow or contain voids 308 or, in the alterative, the voids may be filled with fibers and/or filaments making up the nonwoven web. Attention is also directed to FIG. 6A, which shows a topographical micrograph of a nonwoven web within the present invention. FIG. 6B shows a cross-section micrograph of this nonwoven web.

In the present invention, each of the protrusions or tufts comprises a mixture of a thermoplastic filament and a secondary material. It has been discovered that producing a tufted nonwoven web having both thermoplastic filaments and a secondary material results in a tufted nonwoven web which retains its tufted structure even when saturated or the nonwoven web is wound and unwound from a roll. The nonwoven web of the present invention tends to retain its structure under normal use conditions, such as wiping hard surfaces like floors, counter-tops and the like, whether saturated or not, unlike prior three-dimensional nonwoven webs. Further, the nonwoven web also has higher bulk, and liquid capacity as compared to coform nonwoven webs without tufts.

In addition, the fiber orientation of the fibers in the tufts is different that the fiber orientation in the lands. The fibers in the tufts have a more vertical orientation that the fibers in the lands. In this regard, attention is directed to FIG. 6B which shows the fiber orientation.

The tufted coform nonwoven web of the present invention can have up to about 200 tufts per square inch (about 300,000 per square meter). Generally, there are between about 1 to about 100 tufts per square inch (about 1500 to about 300,000 per square meter). Having between about 1 and about 100 tufts per square inch gives a coform nonwoven web with sufficient bulk and liquid holding capacity. Commercially available forming wires are readily available having between about 9 and about 50 tufts per square inch (about 13,500 to about 75,000 per square meter). Having more than about 200 tufts per square inch tends to reduce the bulk advantage provided by tufts and it is generally harder to prepare coform nonwoven webs having more than about 200 tufts per square inch.

The thermoplastic filaments making-up the coform nonwoven web of the present invention are preferably meltblown filaments prepared from thermoplastic polymers. Suitable thermoplastic polymers useful in the present invention include polyolefins, polyesters, polyamides, polycarbonates, polyurethanes, polyvinylchloride, polytetrafluoroethylene, polystyrene, polyethylene terephthalate, biodegradable polymers such as polylactic acid and copolymers and blends thereof. Suitable polyolefins include polyethylene, e.g., high density polyethylene, medium density polyethylene, low density polyethylene and linear low density polyethylene; polypropylene, e.g., isotactic polypropylene, syndiotactic polypropylene, blends of isotactic polypropylene and atactic polypropylene, and blends thereof; polybutylene, e.g., poly(1-butene) and poly(2-butene); polypentene, e.g., poly(1-pentene) and poly(2-pentene); poly(3-methyl-1-pentene); poly(4-methyl 1-pentene); and copolymers and blends thereof. Suitable copolymers include random and block copolymers prepared from two or more different unsaturated olefin monomers, such as ethylene/propylene and ethylene/butylene copolymers. Suitable polyamides include nylon 6, nylon 6/6, nylon 4/6, nylon 11, nylon 12, nylon 6/10, nylon 6/12, nylon 12/12, copolymers of caprolactam and alkylene oxide diamine, and the like, as well as blends and copolymers thereof. Suitable polyesters include polyethylene terephthalate, polytrimethylene terephthalate, polybutylene terephthalate, polytetramethylene terephthalate, polycyclohexylene-1,4-dimethylene terephthalate, and isophthalate copolymers thereof, as well as blends thereof.

Many polyolefins are available for fiber production, for example polyethylenes such as Dow Chemical's ASPUN 6811A linear low-density polyethylene, 2553 LLDPE and 25355 and 12350 high density polyethylene are such suitable polymers. The polyethylenes have melt flow rates in g/10 min. at 190° F. and a load of 2.16 kg, of about 26, 40, 25 and 12, respectively. Fiber forming polypropylenes include, for example, Basell's PF-015 polypropylene. Many other polyolefins are commercially available and generally can be used in the present invention. The particularly preferred polyolefins are polypropylene and polyethylene.

Examples of polyamides and their methods of synthesis may be found in “Polyamide Resins” by Don E. Floyd (Library of Congress Catalog number 66-20811, Reinhold Publishing, N.Y., 1966). Particularly commercially useful polyamides are nylon 6, nylon-6,6, nylon-11 and nylon-12. These polyamides are available from a number of sources such as Custom Resins, Nyltech, among others. In addition, a compatible tackifying resin may be added to the extrudable compositions described above to provide tackified materials that autogenously bond or which require heat for bonding. Any tackifier resin can be used which is compatible with the polymers and can withstand the high processing (e.g., extrusion) temperatures. If the polymer is blended with processing aids such as, for example, polyolefins or extending oils, the tackifier resin should also be compatible with those processing aids. Generally, hydrogenated hydrocarbon resins are preferred tackifying resins, because of their better temperature stability. REGALREZ® and ARKON® P series tackifiers are examples of hydrogenated hydrocarbon resins. ZONATAC® 501 Lite is an example of a terpene hydrocarbon. REGALREZ® hydrocarbon resins are available from Hercules Incorporated. ARKON®P series resins are available from Arakawa Chemical (USA) Incorporated. The tackifying resins such as disclosed in U.S. Pat. No. 4,787,699, hereby incorporated by reference, are suitable. Other tackifying resins which are compatible with the other components of the composition and can withstand the high processing temperatures can also be used.

The meltblown filaments may be monocomponent fibers, meaning fibers prepared from one polymer component, multiconstituent fibers, or multicomponent fibers. The multicomponent filaments may, for example, have either of an A/B or A/B/A side-by-side configuration, or a sheath-core configuration, wherein one polymer component surrounds another polymer component.

The secondary material of the nonwoven web of the present invention may be an absorbent material, such as absorbent fibers or absorbent particles, or non-absorbent materials, such as non-absorbent fibers or non-absorbent particles. Secondary fibers may generally be fibers such as polyester fibers, polyamide fibers, cellulosic derived fibers such as, for example, rayon fibers and wood pulp fibers, multi-component fibers such as, for example, sheath-core multi-component fibers, natural fibers such as silk fibers, wool fibers or cotton fibers or electrically conductive fibers or blends of two or more of such secondary fibers. Other types of secondary fibers such as, for example, polyethylene fibers and polypropylene fibers, as well as blends of two or more of other types of secondary fibers may be utilized. The secondary fibers may be microfibers, i.e. fibers having a fiber diameter less than 100 microns or the secondary fibers may be macrofibers having an average diameter of from about 100 microns to about 1,000 microns.

The selection of the second material will determine the properties of the resulting the resulting tufted coform material. For example, the absorbency of the tufted coform material can be improved by using an absorbent material as the second material. In the case were absorbency is not necessary or not desired, non-absorbent material may be selected as the secondary material.

The absorbent materials useful in the present invention include absorbent fibers, absorbent particles and mixtures of absorbent fibers and absorbent particles. Examples of the absorbent material include, but are not limited to, fibrous organic materials such as woody or non-woody pulp from cotton, rayon, recycled paper, pulp fluff, inorganic absorbent materials, treated polymeric staple fibers and so forth. Desirably, although not required, the absorbent material is pulp.

The pulp fibers may be any high-average fiber length pulp, low-average fiber length pulp, or mixtures of the same. Preferred pulp fibers include cellulose fibers. The term “high average fiber length pulp” refers to pulp that contains a relatively small amount of short fibers and non-fiber particles. High fiber length pulps typically have an average fiber length greater than about 1.5 mm, preferably about 1.5-6 mm. Sources generally include non-secondary (virgin) fibers as well as secondary fiber pulp which has been screened. The term “low average fiber length pulp” refers to pulp that contains a significant amount of short fibers and non-fiber particles. Low average fiber length pulps typically have an average fiber length less than about 1.5 mm.

Examples of high average fiber length wood pulps include those available from Georgia-Pacific under the trade designations Golden Isles 4821 and 4824. The low average fiber length pulps may include certain virgin hardwood pulp and secondary (i.e., recycled) fiber pulp from sources including newsprint, reclaimed paperboard, and office waste. Mixtures of high average fiber length and low average fiber length pulps may contain a predominance of low average fiber length pulps. For example, mixtures may contain more than about 50% by weight low-average fiber length pulp and less than about 50% by weight high-average fiber length pulp. One exemplary mixture contains about 75% by weight low-average fiber length pulp and about 25% by weight high-average fiber length pulp.

The pulp fibers may be unrefined or may be beaten to various degrees of refinement. Crosslinking agents and/or hydrating agents may also be added to the pulp mixture. Debonding agents may be added to reduce the degree of hydrogen bonding if a very open or loose nonwoven pulp fiber web is desired. Exemplary debonding agents are available from the Quaker Oats Chemical Company, Conshohocken, Pa., under the trade designation Quaker 2028 and Berocell 509ha made by Eka Nobel, Inc. Marietta, Ga. The addition of certain debonding agents in the amount of, for example, 1-4% by weight of the pulp fibers, may reduce the measured static and dynamic coefficients of friction and improve the abrasion resistance of the thermoplastic meltblown polymer filaments. The debonding agents act as lubricants or friction reducers. Debonded pulp fibers are commercially available from Weyerhaeuser Corp. under the designation NB 405.

In addition, non-absorbent secondary materials can be incorporated into the tufted coform nonwoven web, depending on the end use of the tufted coform nonwoven web. For example, in end uses where absorbency is not an issue, non-absorbent secondary materials may be used. These non-absorbent materials include nonabsorbent fibers and nonabsorbent particles. Examples of the fibers include, for example, staple fibers of untreated thermoplastic polymers, such as polyolefins and the like. Examples of nonabsorbent particles include activated charcoal, sodium bicarbonate and the like. The nonabsorbent material can be used alone or in combination with the absorbent material.

An important factor in preparing the three-dimensional tufted coform nonwoven web of the present invention is selection of the forming surface used to prepare the coform nonwoven web. A forming surface is a surface on which the mixture of thermoplastic filaments and the secondary material is deposited during formation. The forming surface can be any type of plate, drum, belt or wire, which is highly permeable and allows for the formation of tufts. As examples, any of the forming surfaces described in U.S. Pat. No. 4,741,941, issued to Englebert et al. can be used to prepare the tufted nonwoven web of the present invention.

The forming surface geometry and processing conditions may be used to alter the tufts of the material. The particular choice will depend on the desired tuft size, shape, depth, surface density (tufts/area), and the like. One skilled in the art could easily determine without undue experimentation the judicious balance of attenuating air and below-wire-vacuum (both described below) required to achieve the desired tuft dimensions and properties. Generally, however, since a forming surface may be used to provide the actual tufts, it is important to use a highly permeable forming surface to allow material to be drawn through the wire to form the tufts. In one aspect, the forming surface can have an open area of between about 35% and about 65%, more particularly about 40% to about 60%, and more particularly about 45% to about 55%. This is as compared with prior art nonwoven forming surfaces that are very dense and closed, having open areas less than about 35%, since primarily only air is pulled through the forming surface for the purpose of helping to hold the nonwoven material being formed on the forming surface.

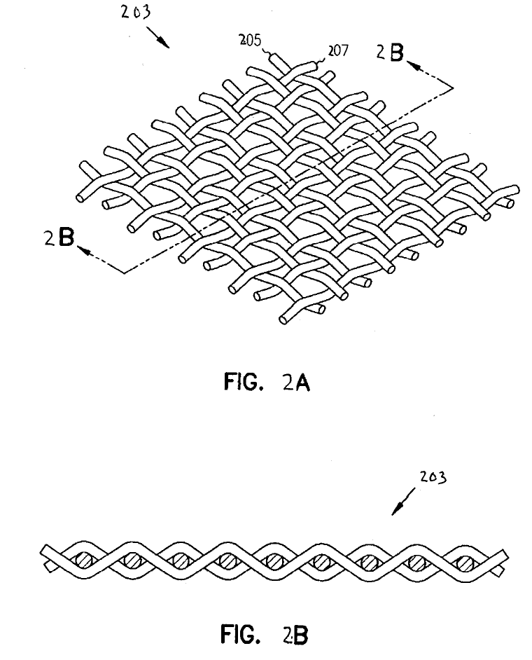

FIG. 2A provides one aspect of a wire forming surface configuration suitable for use with the present invention. As FIG. 2A shows, the forming surface 203 is a wire having machine direction (MD) filaments 205 and cross-machine (CM) filaments 207. FIG. 2B shows a cross-section taken along line 2B-2B. In an exemplary aspect, the forming wire is a “Formtech™ 6” wire manufactured by Albany International Co., Albany, N.Y. Such a wire has a “mesh count” of about six by eight strands per inch (about 2.4 by 3.1 strands per cm), i.e., resulting in 48 tufts per square inch (about 7.4 tufts per square cm), a warp diameter of about one (1) mm polyester, a shute diameter of about 1.07 mm polyester, a nominal air perm of approximately 41.8 m³/min (1475 ft³/min), a nominal caliper of about 0.2 cm (0.08 in) and an open area of approximately 51%. Also, surface variations may include, but are not limited to, alternate weave patterns, alternate strand dimensions, coatings, static dissipation treatments, and the like.

The tufts can have heights from the base plane of up to about 25 mm or more. Generally, the tufts are about 0.1 mm to about 10 mm and usually in the range of about 0.3 mm to about 5.0 mm. The height of the tufts may be easily adjusted by changing the forming conditions (such as increasing or decreasing the attenuating air flow, increasing or decreasing the vacuum under the forming wire) or changing the forming surface.

The three-dimensional tufted coform nonwoven web of the present invention may be prepared by a method including the following steps:

a. providing at least one stream of meltblown filaments;

b. providing at least one stream containing at least one secondary material;

c. converging the at least one stream containing at least one secondary material with the at least one stream of meltblown filaments to form a composite stream;

d. depositing the composite stream onto a shaped forming surface as a matrix of meltblown filaments and at least one secondary material;

e. optionally applying a pressure differential to the matrix while on the forming surface to form a nonwoven web having an array of projections and land areas corresponding to the shaped forming surface; and

f. separating the nonwoven web from the shaped forming surface.

The forgoing steps may be practiced in a variety of manners including one of the following methods, which illustrate steps that can be used in accordance with the present invention to form the tufted nonwoven web.

In another method, three-dimensional tufted coform nonwoven web of the present invention is prepared by a method including:

1. providing a first stream of meltblown filaments;

2. providing a second stream of meltblown filaments;

3. converging the first stream of meltblown filaments and the second stream of meltblown filaments in an intersecting relationship to form an impingement zone;

4. introducing a stream containing at least one secondary material between the first and second streams of the meltblown filaments at or near the impingement zone to form a composite stream;

5. depositing the composite stream onto a shaped forming surface as a matrix of meltblown filaments and at least one secondary material;

6. optionally applying a pressure differential to the matrix while on the forming surface to form a nonwoven web having an array of projections and land areas corresponding to the shaped forming surface; and

7. separating the nonwoven web from the shaped forming surface.

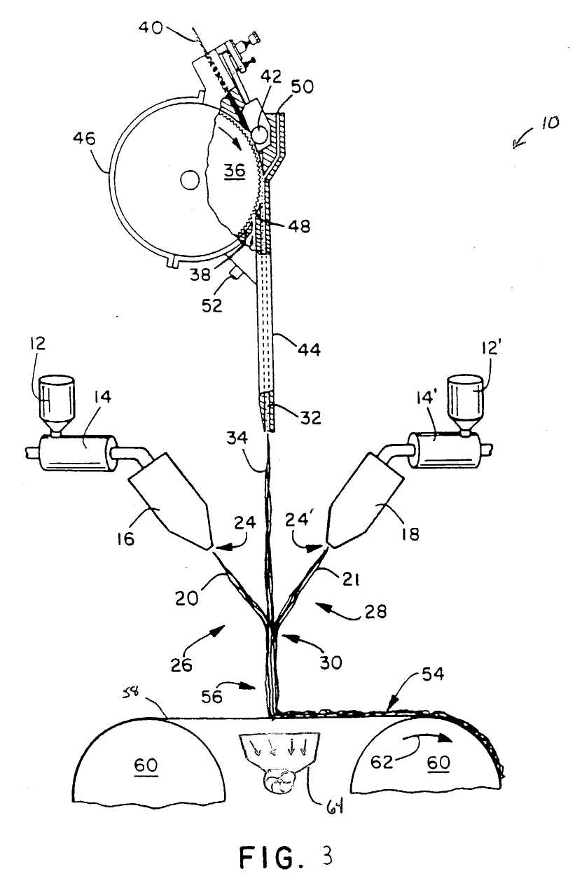

In order to obtain a better understanding of how to produce the three dimensional tufted coform nonwoven web of the present invention, attention is directed to FIG. 3. FIG. 3 shows an exemplary apparatus for forming a three-dimensional tufted coform nonwoven web which is generally represented by reference numeral 10. In forming the three-dimensional coform nonwoven web of the present invention, pellets or chips, etc. (not shown) of a thermoplastic polymer are introduced into a pellet hopper 12, or 12′ of an extruder 14 or 14′, respectively.

The extruders 14 and 14′ each have an extrusion screw (not shown), which is driven by a conventional drive motor (not shown). As the polymer advances through the extruders 14 and 14′, due to rotation of the extrusion screw by the drive motor, it is progressively heated to a molten state. Heating the thermoplastic polymer to the molten state may be accomplished in a plurality of discrete steps with its temperature being gradually elevated as it advances through discrete heating zones of the extruders 14 and 14′ toward two meltblowing dies 16 and 18, respectively. The meltblowing dies 16 and 18 may be yet another heating zone where the temperature of the thermoplastic resin is maintained at an elevated level for extrusion.

Each meltblowing die is configured so that two streams of attenuating gas per die converge to form a single stream of gas which entrains and attenuates molten threads 20 and 21, as the threads 20 and 21 exit small holes or orifices 24 and 24′, respectively in each meltblowing die. The molten threads 20 and 21 are formed into fibers or, depending upon the degree of attenuation, microfibers, of a small diameter which is usually less than the diameter of the orifices 24. Thus, each meltblowing die 16 and 18 has a corresponding single stream of gas 26 and 28 containing entrained thermoplastic polymer fibers. The gas streams 26 and 28 containing polymer fibers are aligned to converge at an impingement zone 30.

One or more types of secondary fibers 32 and/or particulates are added to the two streams 26 and 28 of thermoplastic polymer fibers 20 and 21, respectively, and at the impingement zone 30. Introduction of the secondary fibers 32 into the two streams 26 and 28 of thermoplastic polymer fibers 20 and 21, respectively, is designed to produce a graduated distribution of secondary fibers 32 within the combined streams 26 and 28 of thermoplastic polymer fibers. This may be accomplished by merging a secondary gas stream 34 containing the secondary fibers 32 between the two streams 26 and 28 of thermoplastic polymer fibers 20 and 21 so that all three gas streams converge in a controlled manner.

Apparatus for accomplishing this merger may include a conventional picker roll 36 arrangement which has a plurality of teeth 38 that are adapted to separate a mat or batt 40 of secondary fibers into the individual secondary fibers 32. The mat or batt of secondary fibers 40 which is fed to the picker roll 36 may be a sheet of pulp fibers (if a two-component mixture of thermoplastic polymer fibers and secondary pulp fibers is desired), a mat of staple fibers (if a two-component mixture of thermoplastic polymer fibers and a secondary staple fibers is desired) or both a sheet of pulp fibers and a mat of staple fibers (if a three-component mixture of thermoplastic polymer fibers, secondary staple fibers and secondary pulp fibers is desired). In embodiments where, for example, an absorbent material is desired, the secondary fibers 32 are absorbent fibers. The secondary fibers 32 may generally be selected from the group including one or more polyester fibers, polyamide fibers, cellulosic derived fibers such as, for example, rayon fibers and wood pulp fibers, multi-component fibers such as, for example, sheath-core multi-component fibers, natural fibers such as silk fibers, wool fibers or cotton fibers or electrically conductive fibers or blends of two or more of such secondary fibers. Other types of secondary fibers 32 such as, for example, polyethylene fibers and polypropylene fibers, as well as blends of two or more of other types of secondary fibers 32 may be utilized. The secondary fibers 32 may be microfibers or the secondary fibers 32 may be macrofibers having an average diameter of from about 100 microns to about 1,000 microns.

The sheets or mats 40 of secondary fibers 32 are fed to the picker roll 36 by a roller arrangement 42. After the teeth 38 of the picker roll 36 have separated the mat of secondary fibers 40 into separate secondary fibers 32 the individual secondary fibers 32 are conveyed toward the stream of thermoplastic polymer fibers or microfibers 24 through a nozzle 44. A housing 46 encloses the picker roll 36 and provides a passageway or gap 48 between the housing 46 and the surface of the teeth 38 of the picker roll 36. A gas, for example, air, is supplied to the passageway or gap 46 between the surface of the picker roll 36 and the housing 48 by way of a gas duct 50.

The gas duct 50 may enter the passageway or gap 46 generally at the junction 52 of the nozzle 44 and the gap 48. The gas is supplied in sufficient quantity to serve as a medium for conveying the secondary fibers 32 through the nozzle 44. The gas supplied from the duct 50 also serves as an aid in removing the secondary fibers 32 from the teeth 38 of the picker roll 36. The gas may be supplied by any conventional arrangement such as, for example, an air blower (not shown). It is contemplated that additives and/or other materials may be added to or entrained in the gas stream to treat the secondary fibers.

Generally speaking, the individual secondary fibers 32 are conveyed through the nozzle 44 at about the velocity at which the secondary fibers 32 leave the teeth 38 of the picker roll 36. In other words, the secondary fibers 32, upon leaving the teeth 38 of the picker roll 36 and entering the nozzle 44 generally maintain their velocity in both magnitude and direction from the point where they left the teeth 38 of the picker roll 36. Such an arrangement, which is discussed in more detail in U.S. Pat. No. 4,100,324 to Anderson, et al., hereby incorporated by reference, aids in substantially reducing fiber floccing.

The width of the nozzle 44 should be aligned in a direction generally parallel to the width of the meltblowing dies 16 and 18. Desirably, the width of the nozzle 44 should be about the same as the width of the meltblowing dies 16 and 18. Usually, the width of the nozzle 44 should not exceed the width of the sheets or mats 40 that are being fed to the picker roll 36. Generally speaking, it is desirable for the length of the nozzle 44 to be as short as equipment design will allow.

The picker roll 36 may be replaced by a conventional particulate injection system to form a coform nonwoven structure 54 containing various secondary particulates. A combination of both secondary particulates and secondary fibers could be added to the thermoplastic polymer fibers prior to formation of the coform nonwoven structure 54 if a conventional particulate injection system was added to the system illustrated in FIG. 3. The particulates may be, for example, charcoal, clay, starches, and/or superabsorbent particles.

FIG. 3 further illustrates that the secondary gas stream 34 carrying the secondary fibers 32 is directed between the streams 26 and 28 of thermoplastic polymer fibers so that the streams contact at the impingement zone 30. The velocity of the secondary gas stream 34 may be adjusted. If the velocity of the secondary gas stream is adjusted so that it is greater than the velocity of each stream 26 and 28 of thermoplastic polymer fibers 20 and 21 when the streams contact at the impingement zone 30, the secondary material is incorporated in the coform nonwoven web in a gradient structure. That is, the secondary material has a higher concentration between the outer surfaces of the coform nonwoven web than at the outer surfaces. If the velocity of the secondary gas stream 34 is less than the velocity of each stream 26 and 28 of thermoplastic polymer fibers 20 and 21 when the streams contact at the impingement zone 30, the secondary material is incorporated in the coform nonwoven web in a substantially homogenous fashion. That is, the concentration of the secondary material is substantially the same throughout the coform nonwoven web. This is because the low-speed stream of secondary material is drawn into a high-speed stream of thermoplastic polymer fibers to enhance turbulent mixing which results in a consistent distribution of the secondary material.

Although the inventors should not be held to a particular theory of operation, it is believed that adjusting the velocity of the secondary gas stream 34 so that it is greater than the velocity of each stream 26 and 28 of thermoplastic polymer fibers 24 when the streams intersect at the impingement zone 30 can have the effect that, during merger and integration thereof, between the impingement zone 30 and a collection surface, a graduated distribution of the fibrous components can be accomplished.

The velocity difference between the gas streams may be such that the secondary fibers 32 are integrated into the streams of thermoplastic polymer fibers 26 and 28 in such manner that the secondary material 32 become gradually and only partially distributed within the thermoplastic polymer fibers 20 and 21. Generally, for increased production rates the gas streams which entrain the thermoplastic polymer fibers 20 and 21 may have a comparatively high initial velocity, for example, from about 200 feet to over 1,000 feet per second. However, the velocity of those gas streams decreases rapidly as they expand and become separated from the meltblowing die. Thus, the velocity of those gas streams at the impingement zone may be controlled by adjusting the distance between the meltblowing die and the impingement zone. The stream of gas 34 which carries the secondary fibers 32 will have a low initial velocity when compared to the gas streams 26 and 28 which carry the meltblown fibers. However, by adjusting the distance from the nozzle 44 to the impingement zone 30 (and the distances that the meltblown fiber gas streams 26 and 28 must travel), the velocity of the gas stream 34 can be controlled to be greater or lower than the meltblown fiber gas streams 26 and 28. In the practice of the present invention, it is preferred that the secondary material is homogenously integrated with the meltblown filaments. In addition, the velocity of the thermoplastic fiber streams may also be adjusted to obtain the desired degree of mixing.

Due to the fact that the thermoplastic polymer fibers 20 and 21 are usually still semi-molten and tacky at the time of incorporation of the secondary fibers 32 into the thermoplastic polymer fiber streams 26 and 28, the secondary fibers 32 are usually not only mechanically entangled within the matrix formed by the thermoplastic polymer fibers 20 and 21 but are also thermally bonded or joined to the thermoplastic polymer fibers 20 and 21.

In order to convert the composite stream 56 of thermoplastic polymer fibers 20, 21 and secondary material 32 into a coform nonwoven structure 54, a collecting device is located in the path of the composite stream 56. The collecting device may be an endless forming surface 58 conventionally driven by rollers 60 and which is rotating as indicated by the arrow 62 in FIG. 3. Other collecting devices are well known to those of skill in the art and may be utilized in place of the endless forming wire 58. For example, a porous rotating drum arrangement could be utilized. The merged streams of thermoplastic polymer fibers and secondary fibers are collected as a coherent matrix of fibers on the surface of the endless forming surface 58 to form the coform nonwoven web 54. Vacuum boxes 64 assist in retention of the matrix on the surface of the endless forming surface 58.

In the present invention, the vacuum box assists in pulling the meltblown filaments and secondary material into the forming surface. Generally, the vacuum is operated at a condition which is sufficient to pull the meltblown filament and secondary material into the forming surface but not high enough to pull the secondary material and meltblown filaments through the forming surface, forming apertures in the resulting nonwoven web. Generally, a vacuum up to about 25 inches of water gauge is more than sufficient for the present invention. In contrast, if the forming surface is not porous but has protrusions, a vacuum system below the forming surface may not be necessary.

The coform structure 54 is coherent and may be removed from the forming surface or wire 58 as a self-supporting nonwoven material. Generally speaking, the coform structure has adequate strength and integrity to be used without any post-treatments such as pattern bonding and the like.

Optionally, a second layer of coform may be applied onto the first deposited layer. If the second layer is provided on the coform material, before the coform is separated from the shaped forming surface, the process includes the additional process steps of:

d1. providing a second stream of meltblown filaments

d2. introducing a stream at least one secondary material to the second stream of meltblown filaments to form a second composite stream;

d3. depositing the second composite stream onto the deposited layer as a matrix of meltblown filaments and a secondary material to for a two layer tufted coform nonwoven web.

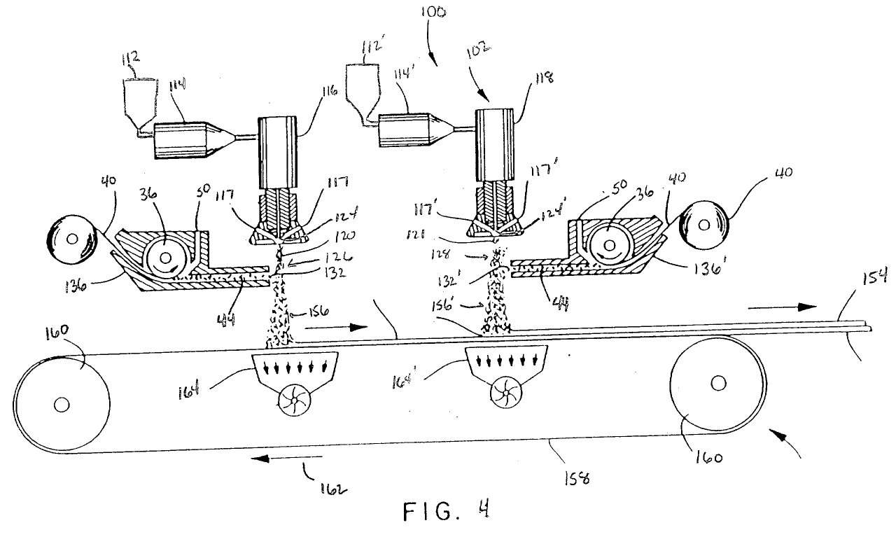

If the second layer is desired to be added to the first layer of the tufted coform material, the first method of the present invention can be repeated twice on the same forming wire. In an alternative method, only one meltblown head is used in a second method of the present invention. In this regard, attention is directed to FIG. 4, which shows an exemplary apparatus for forming a three dimensional coform nonwoven web which is generally represented by reference numeral 100, including the optional steps providing a second layer of coform using the second bank of the coforming apparatus 102. The second bank of coforming apparatus does not have to be operated to produce the tufted coform nonwoven web of the present invention. In forming the three dimensional coform nonwoven web of the present invention, pellets or chips, etc. (not shown) of a thermoplastic polymer are introduced into a pellet hopper 112, or 112′ of an extruder 114 or 114′, respectively.

The extruders 114 and 114′ each have an extrusion screw (not shown), which is driven by a conventional drive motor (not shown). As the polymer advances through the extruders 114 and 114′, due to rotation of the extrusion screw by the drive motor, it is progressively heated to a molten state. Heating the thermoplastic polymer to the molten state may be accomplished in a plurality of discrete steps with its temperature being gradually elevated as it advances through discrete heating zones of the extruders 114 and 114′ toward two meltblowing dies 116 and 118, respectively. The meltblowing dies 116 and 118 may be yet another heating zone where the temperature of the thermoplastic resin is maintained at an elevated level for extrusion.

Each meltblowing die is configured so that two streams of attenuating gas 117 and 117′ per die converge to form a single stream of gas which entrains and attenuates molten threads 120 and 121, as the threads 120 and 121 exit small holes or orifices 124 and 124′, respectively. The molten threads 120 and 121 are formed into filaments or, depending upon the degree of attenuation, microfibers, of a small diameter which is usually less than the diameter of the orifices 124 and 124′. Thus, each meltblowing die 116 and 118 has a corresponding single stream of gas 126 and 128 containing entrained thermoplastic polymer fibers. The gas streams 126 and 128 containing polymer fibers directed toward the forming surface and are generally preferred to be substantially perpendicular to the forming surface.

One or more types of secondary fibers 132 and 132′ and/or particulates are added to the two streams 126 and 128 of thermoplastic polymer fibers 120 and 121, respectively. Introduction of the secondary fibers 132 and 132′ into the two streams 126 and 128 of thermoplastic polymer fibers 120 and 121, respectively, is designed to produce a generally homogenous distribution of secondary fibers 132 and 132′ within streams 126 and 128 of thermoplastic polymer fibers.

Apparatus for accomplishing this merger may include a conventional picker roll 136 and 136′. The operation of a conventional picker roll is described above for in the discussion of FIG. 3. The picker rolls 136 and 136′ may be replaced by a conventional particulate injection system to form a coform nonwoven structure 154 containing various secondary particulates. A combination of both secondary particulates and secondary fibers could be added to the thermoplastic polymer fibers prior to formation of the coform nonwoven structure 154 if a conventional particulate injection system was added to the system illustrated in FIG. 3. The particulates may be, for example, charcoal, clay, starches, and/or superabsorbent particles.

Due to the fact that the thermoplastic polymer fibers 120 and 121 are usually still semi-molten and tacky at the time of incorporation of the secondary fibers 132 and 132′ into the thermoplastic polymer fiber streams 126 and 128, the secondary fibers 132 and 132′ are usually not only mechanically entangled within the matrix formed by the thermoplastic polymer fibers 120 or 121′ but are also thermally bonded or joined to the thermoplastic polymer fibers 120 or 121′.

In order to convert the composite stream 156 and 156′ of thermoplastic polymer fibers 120, 121 and secondary material 132 and 132′, respectively, into a coform nonwoven structure 154, a collecting device is located in the path of the composite streams 156 and 156′. The collecting device may be an endless forming surface 158 conventionally driven by rollers 160 and which is rotating as indicated by the arrow 162 in FIG. 4. Other collecting devices described above can be utilized as the endless forming surface 158. The merged streams of thermoplastic polymer fibers and secondary fibers are collected as a coherent matrix of fibers on the surface of the endless forming surface 158 to form the coform nonwoven web 154. Vacuum boxes 164 and 164′ assist in retention of the matrix on the surface of the forming surface 158.

The coform structure 154 is coherent and may be removed from the forming surface 158 as a self-supporting nonwoven material. Generally speaking, the coform structure has adequate strength and integrity to be used without any post-treatments such as pattern bonding, calendering and the like.

As is stated above, the second bank of the coforming apparatus does not have to be operated to form the tufted coform nonwoven web of the present invention. However, if the second bank is operated, the resulting tufted coform material will be thicker and have a higher capacity to store or absorb liquids as compared to a tufted coform material without the second layer of coform. It is further noted that a second bank of coform forming apparatus shown in FIG. 3 may be added to the process of FIG. 3.

The tufted coform material preferably has a total basis weight in the range of about 34 gsm to about 600 gsm. More preferably, the basis weight is in the range of about 75 gsm to about 400 gsm. Most preferably, the basis weight should be in the range of about 100 gsm to about 325 gsm. It is pointed out, however, that the basis weight is highly dependent on the end use. For pre-saturated mop applications it is preferred that the basis weight is about 75 gsm to about 325 gsm, while the basis weight for a absorbent mop is preferably in the range of about 175 gsm to about 325 gsm. For hand wipes and the like, the basis weight is generally dependent of the particular utility of the wipe. In the production of the tufted coform by the apparatus of FIG. 3 or FIG. 4, the percentage of the basis weight can be varied. The basis weight may be adjusted by several different ways, including, for example by adjusting the speed of the forming surface. As the speed of the forming surface increase, the basis weight decreases. Likewise, as the speed of the forming surface decreases, the basis weight increases. Other methods of controlling the basis weight include adjusting the through-put of the picker and meltblown heads. Lower through-puts result in lower basis weights. Adding a second layer to the tufted coform material also increases the basis weight.

In the practice of the present invention, the matrix of the thermoplastic polymer and the secondary material contains between about 15% and 85% by weight of the secondary material and between about 85% and 15% by weight of the thermoplastic filaments, based on the weight of the thermoplastic filaments and secondary material. For certain applications, the matrix contains between about 20% and 65% by weight of the secondary material and between 35% and 80% by weight of the thermoplastic filaments. Preferably, the coform matrix contains between about 20% and about 50% by weight of the secondary material and between about 50% and 80% by weight of the thermoplastic filaments, especially in applications where low linting is desired. Linting occurs when the secondary material is not fully captured by the thermoplastic filaments. In the tufted coform of the present invention, when the amount of the secondary material is above about 50-55% by weight of the matrix, the secondary material may tend to lint from the matrix. If Tinting is not a concern, then the amount of the secondary material can be increased above the 50-55% by weight of the matrix.

If additional layers of coform are layered onto the tufted coform layer, the percentage of secondary material in the additional layers can be greater than 50-55%. In fact, the additional layers may contain as much as about 85 % by weight of the secondary material. Having additional layers with greater percentage of the secondary material results in a coform with a gradient type structure. If the secondary material is absorbent, having a greater percentage of the secondary material in the additional layers will result in a coform material having improved absorbency. If the tufted coform is to be used as a pre-moistened wipe or the like, the gradient type structure will result in a high liquid holding capacity than without the additional layer.

In order to improve the toughness of the tufted coform of the present invention, a portion of the thermoplastic composition used to prepare the thermoplastic filaments may include polybutylene. When the thermoplastic polymer is a polyolefin, a portion of the thermoplastic polymer, up to about 25% by weight based on the total weight of the thermoplastic polymer, can be polybutylene which will improve the toughness of the resulting coform material. In applications where toughness is not desired or required, the polybutylene does not have to be included. However, it is preferred that the polybutylene is present in an amount between about 5% to about 20% by weight, based on the total weight of the thermoplastic filaments.

Typically, coform is prepared from fine fiber meltblown, having an average fiber diameter less than about 15 microns, desirably between about 1 and 10 micron and generally between about 2 and 7 microns. In the present invention, the meltblown filaments may be prepared to have a mildly abrasive characteristic. This is accomplished by producing thermoplastic filaments which are coarser meltblown fibers, which have a fiber diameter larger than the fine meltblown fibers. The coarser meltblown fibers generally have an average fiber diameter greater than about 15 microns. The coarse meltblown fibers can have fiber diameter in excess of 40 microns, but the average fiber diameter is between about 15 and 39 microns.

The characteristics of the meltblown filaments can be adjusted by manipulation of the various process parameters used for each extruder and die head in carrying out the meltblowing process. The following parameters can be adjusted and varied for each extruder and die head in order to change the characteristics of the resulting meltblown filaments:

1. Type of Polymer,

2. Polymer throughput (pounds per inch of die width per hour—PIH),

3. Polymer melt temperature,

4. Air temperature,

5. Air flow (standard cubic feet per minute, SCFM, calibrated for the width of the die head),

6. Distance from between die tip and forming surface and

7. Vacuum under forming surface.

For example, the coarse filaments may be prepared by reducing the primary air temperature from the range of about 600°-640° F. (316°-338° C.) to about 420°-460° F. (216°-238° C.) for the coarse filament bank. These changes result in the formation of larger fibers. Any other method which is effective may also be used and would be in keeping with the invention.

Preparing the coform nonwoven web by the first method disclosed above, shown in FIG. 3, has some additional advantages over the process of FIG. 4. The advantage is that intermingling the fine meltblown filaments, coarse meltblown filaments and pulp. One of the meltblown dies can be operated to form coarse fibers and the other can be operated to form fine fibers. This will result in tufts having both the smooth characteristics of the fine fibers and the abrasive characteristic of the coarse fibers, giving a surface which is mildly abrasive. In the alternative, the mildly abrasive characteristic may be accomplished by producing fine fibers near about 15 microns in diameter.

The coform material of the present invention can be prepared on or laminated to an additional material. It is pointed out that this lamination is not required in the present invention. For example, an additional material may be supplied to the process of FIG. 3 or FIG. 4 after the formation of the coform material. The additional layer may be laminated to the tufted coform of the present invention after the coform is formed. As is noted above, lamination of an additional material to the coform is not required; however, if the secondary material content is greater than about 65-70% by weight in the coform material, it is preferred that an additional layer be placed onto the coform material to help prevent the secondary material from “linting” out of the coform.

The additional layer can provide additional strength to the coform or provide other properties, such as barrier properties. Laminating another material to the fine filament side of the coform is especially useful in mop applications, by providing extra strength to the nonwoven web and by providing a liquid barrier between the mop material and the mop attachment means. Examples of barrier materials include, for example such as polymeric films, laminate nonwoven materials, combinations thereof and the like. Generally, any material which is liquid impervious may be any suitable. Examples of strengthening layers include, nonwoven webs, such as spunbond, bonded carded webs and the liked, knitted webs, and woven materials. These materials are known to those skilled in the art and are readily available.

Due to cost considerations, spunbond materials may be laminated to the fine filament side of the nonwoven web in order to provide additional strength to the coform material, if a material is to be laminated to the coform nonwoven web of the present invention. Typically, a spunbond having a basis weight in the range of 0.1 osy (3.4 gsm) to about 2.0 osy (68 gsm) may be used. A spunbond having a basis weight from about 0.2 osy (6.8 gsm) to about 0.8 osy (27 gsm) is desired.

In another alternative laminate structure of the present invention, the coform nonwoven web may also have a barrier layer. The liquid barrier layer desirably comprises a material that substantially prevents the transmission of liquids under the pressures and chemical environments associated with surface cleaning applications. Desirably, the liquid barrier layer comprises a thin, monolithic film. The film desirably comprises a thermoplastic polymer such as, for example, polyolefins (e.g., polypropylene and polyethylene), polycondensates (e.g., polyamides, polyesters, polycarbonates, and polyarylates), polyols, polydienes, polyurethanes, polyethers, polyacrylates, polyacetals, polyimides, cellulose esters, polystyrenes, fluoropolymers and so forth. Desirably, the film is hydrophobic. Additionally, the film desirably has a thickness less than about 2 mil and still more desirably between about 0.5 mil and about 1 mil. As a particular example, the liquid barrier layer can comprise an embossed, polyethylene film having a thickness of approximately 1 mil. The liquid barrier layer can be bonded together with the other layer or layers of the cleaning sheet to form an integrated laminate through the use of adhesives.

In a further aspect, the layers can be attached by mechanical means such as, for example, by stitching. Still further, the multiple layers can be thermally and/or ultrasonically laminated together to form an integrated laminate. The method of bonding is not critical to the present invention. Desirably, the layers are thermally or ultrasonically bonded together using patterned bonding. In addition, if the coform material is a single layer, it may be pattern bonded to form an aesthetically pleasing material. Pattern bonding a single layer material may also improve the scrubbing ability of the resulting material as well as the laminates.

Various bond patterns have been developed for functional as well as aesthetic reasons. In this regard, the layers are desirably bonded over less than the entire surface area of the fabric using an intermittent or spaced pattern of bond areas. Desirably, the bond area is between about 2% and about 20% of the surface area of the fabric and still more desirably between about 4% and about 15% of the fabric. Still further, the bonding pattern desirably employs a pattern comprising a plurality of spaced, repeating bond segments. While various bond patterns can be used, desirably a bond pattern is employed comprising a series of elongated bond segments and even more desirably comprise substantially continuous bonding line segments or continuous boding lines. Sinusoidal bonding patterns are believed particularly well suited. Further, the bonding lines desirably extend around the entire product. In addition, when using a series of discontinuous and/or discrete bond segments it is further desirable that the patterns have a series of staggered and/or offset bond segments such that the unbonded areas are not vertically aligned. By providing bond segments such as described above it is believed that uniform liquid retention throughout the laminate is obtained since the compressed bonded areas will substantially limit downward flow of liquid within the absorbent. As specific examples, continuous sinusoidal bonding patterns and/or staggered discontinuous sinusoidal line segments are disclosed in U.S. Design Pat. Nos. 247,370; 247,371; 433,131 and 433,132; the entire contents of each of the aforesaid references are incorporated herein by reference.

As an alternative, two tufted coform nonwoven webs could be laminated together so that both sides of the laminated product has tufts. Any bonding method could be used so long as the tufts are retained on both sides of the resulting laminate. Such a laminate may especially useful in wiper applications.

The three-dimensional tufted coform nonwoven web of the present invention can be used to form a pre-saturated or absorbent cleaning sheet, used as a wiper, a sheet for a mop or other hand held implements. The term “cleaning sheet” encompasses dry wipes, pre-saturated wipes, absorbent mops, pre-saturated mops and the like. The size and shape of the cleaning sheet can vary with respect to the intended application and/or end use of the same. Desirably, the cleaning sheet has a substantially rectangular shape of a size which allows it to readily engage standard cleaning equipment or tools such as, for example, mop heads, duster heads, brush heads and so forth. For example, the cleaning sheet may have an unfolded length of from about 2.0 to about 80.0 centimeters and desirably from about 10.0 to about 25.0 centimeters and an unfolded width of from about 2.0 to about 80.0 centimeters and desirably from about 10.0 to about 25.0 centimeters. As one particular example, in order to fit a standard mop head, the cleaning sheet may have a length of about 28 cm and a width of about 22 cm. However, the particular size and/or shape of cleaning sheet can vary as needed to fit upon or otherwise conform to a specific cleaning tool. In an alternative configuration, the cleaning sheet of the present invention could be formed into a mitten shaped article for wiping and cleaning, which would fit over the user's hand.

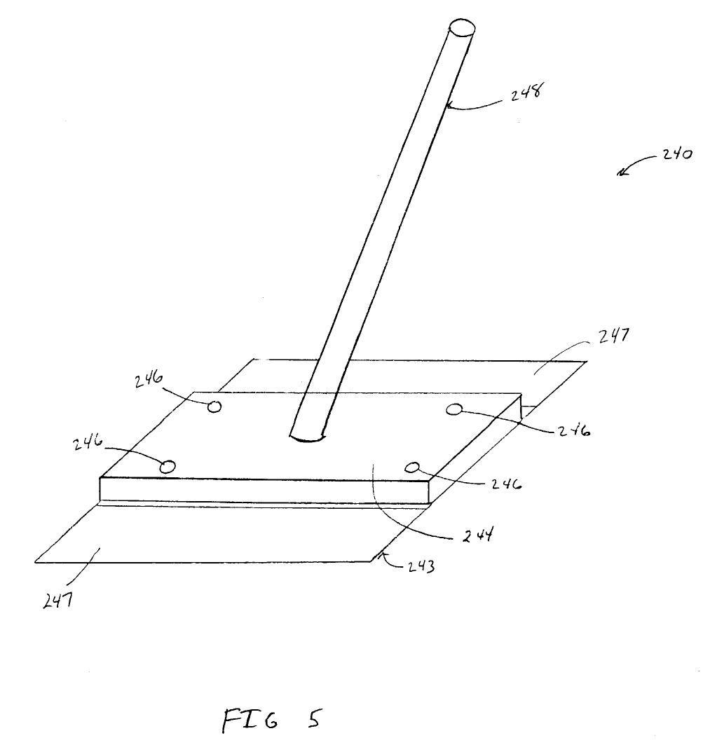

As indicated herein above, the cleaning sheets of the present invention are well suited for use with a variety of cleaning equipment and, more particularly, are readily capable of being releasably-attached to the head of a cleaning tool. As used herein, “releasably-attached” or “releasably-engaged” means that the sheet can be readily affixed to and thereafter readily removed from the cleaning tool. In reference to FIG. 5, cleaning tool 240 can comprise handle 248, head 244 and fasteners 246. Cleaning sheet 243 can be superposed with and placed against head 244 such that the liquid barrier layer, if present, faces head 244. If the cleaning sheet is a multilayer laminate, the side of the sheet with the abrasive surface should face away from the head. Flaps 247 can then be wrapped around head 244 and releasably-attached to head 244 by fasteners 246, e.g. clamps. With cleaning sheet 243 affixed to head 244, cleaning tool 240 can then be used in one or more wet and/or dry cleaning operations. Thereafter, when the cleaning sheet becomes heavily soiled or otherwise spent, the used sheet can be quickly and easily removed and a new one put in its place. The specific configuration of the cleaning tool can vary in many respects. As examples, the size and/or shape of the handle can vary, the head can be fixed or moveable (e.g. pivotable) with relation to the handle, the shape and/or size of the head can vary, etc. Further, the composition of the head can itself vary, as but one example the head can comprise a rigid structure with or without additional padding. Further, the mechanism(s) for attaching the cleaning sheet can vary and exemplary means of attachment include, but are not limited to, hook and loop type fasteners (e.g. VELCRO™ fasteners), clamps, snaps, buttons, flaps, cinches, low tack adhesives and so forth.

The cleaning sheets of the present invention are well suited for a variety of dry and wet cleaning operations such as: mopping floors; cleaning of dry surfaces: cleaning and drying wet surfaces such as counters, tabletops or floors (e.g. wet surfaces resulting from spills); sterilizing and/or disinfecting surfaces by applying liquid disinfectants; wiping down and/or cleaning appliances, machinery or equipment with liquid cleansers; rinsing surfaces or articles with water or other diluents (e.g. to remove cleaners, oils, etc.), removing dirt, dust and/or other debris and so forth. The cleaning sheets have numerous uses as a result of its combination of physical attributes, especially the uptake and retention dirt, dust and/or debris. Additionally, the cleaning sheet provides a durable cleaning surface with good abrasion resistance. This combination of physical attributes is highly advantageous for cleaning surfaces with or without liquids such as soap and water or other common household cleaners. Further, the cleaning fabrics of the present invention are of a sufficiently low cost to allow disposal after either a single use or a limited number of uses. By providing a disposable cleaning sheet it is possible to avoid problems associated with permanent or multi-use absorbent products such as, for example, cross-contamination and the formation of bad odors, mildew, mold, etc.

The cleaning sheets can be provided dry or pre-moistened. In one aspect, dry cleaning sheets can be provided with solid cleaning or disinfecting agents coated on or in the sheets. In addition, the cleaning sheets can be provided in a pre-moistened condition. The pre-moistened of the present invention contain the tufted coform nonwoven web of the present invention and a liquid which partially or fully saturates the coform material. The wet cleaning sheets can be maintained over time in a sealable container such as, for example, within a bucket with an attachable lid, sealable plastic pouches or bags, canisters, jars, tubs and so forth. Desirably the wet, stacked cleaning sheets are maintained in a resealable container. The use of a resealable container is particularly desirable when using volatile liquid compositions since substantial amounts of liquid can evaporate while using the first sheets thereby leaving the remaining sheets with little or no liquid. Exemplary resealable containers and dispensers include, but are not limited to, those described in U.S. Pat. No. 4,171,047 to Doyle et al., U.S. Pat. No. 4,353,480 to McFadden, U.S. Pat. No. 4,778,048 to Kaspar et al., U.S. Pat. No. 4,741,944 to Jackson et al., U.S. Pat. No. 5,595,786 to McBride et al.; the entire contents of each of the aforesaid references are incorporated herein by reference. The cleaning sheets can be incorporated or oriented in the container as desired and/or folded as desired in order to improve ease of use or removal as is known in the art. Such folded configurations are well known to those skilled in the art and include c-folded, z-folded, quarter-folded configurations and the like. The stack of folded wet wipes may be placed in the interior of a container, such as a plastic tub, to provide a package of wet wipes for eventual sale to the consumer. Alternatively, the wet wipes may include a continuous strip of material which has perforations between each wipe and which may be arranged in a stack or wound into a roll for dispensing.

With regard to pre-moistened sheets, a selected amount of liquid is added to the container such that the cleaning sheets contain the desired amount of liquid. Typically, the cleaning sheets are stacked and placed in the container and the liquid subsequently added thereto. The sheet can subsequently be used to wipe a surface as well as act as a vehicle to deliver and apply cleaning liquids to a surface. The moistened and/or saturated cleaning sheets can be used to treat various surfaces. As used herein “treating” surfaces is used in the broad sense and includes, but is not limited to, wiping, polishing, swabbing, cleaning, washing, disinfecting, scrubbing, scouring, sanitizing, and/or applying active agents thereto. The amount and composition of the liquid added to the cleaning sheets will vary with the desired application and/or function of the wipes. As used herein the term “liquid” includes, but is not limited to, solutions, emulsions, suspensions and so forth. Thus, liquids may comprise and/or contain one or more of the following: disinfectants; antiseptics; diluents; surfactants, such as nonionic, anionic, cationic, waxes; antimicrobial agents; sterilants; sporicides; germicides; bactericides; fungicides; virucides; protozoacides; algicides; bacteriostats; fungistats; virustats; sanitizers; antibiotics; pesticides; and so forth. Numerous cleaning compositions and compounds are known in the art and can be used in connection with the present invention. The liquid may also contain lotions and/or medicaments. The present invention also relates to new cleaning sheets which have an abrasive scrubbing surface while maintaining adequate strength and resiliency. The premoistened cleaning sheets of the present invention can be used for, hand wipes, face wipes, cosmetic wipes, household wipes, industrial wipes and the like.

The amount of liquid contained within each pre-moistened cleaning sheet may vary depending upon the type of material being used to provide the pre-moistened cleaning sheet, the type of liquid being used, the type of container being used to store the wet wipes, and the desired end use of the wet wipe. Generally, each pre-moistened cleaning sheet can contain from about 150 to about 900 weight percent, depending on the end use. For example, for a low lint countertop or glass wipe a saturation level of about 150 to about 650 weight percent is desirable. For a pre-saturated mop application, the saturation level is desirably from about 500 to about 900 weight percent liquid based on the dry weight of the cleaning sheet, preferably about 650 to about 800 weight percent. If the amount of liquid is less than the above-identified ranges, the cleaning sheet may be too dry and may not adequately perform. If the amount of liquid is greater than the above-identified ranges, the cleaning sheet may be oversaturated and soggy and the liquid may pool in the bottom of the container.

The cleaning sheets of the present invention can be provided in a kit form, wherein a plurality of cleaning sheets and a cleaning tool are provided in a single package.

It has been discovered that the tufted nonwoven web of the present invention has better cleaning ability as compared to prior tufted nonwoven webs. Specifically, the tufts tend retain their structure for cleaning, even when wet, wound and unwound from a roll, and do not have a slippery feeling when wet.

### EXAMPLES

### Example 1

Using the process described in FIG. 3, a tufted coform nonwoven web was formed on a forming wire available from Albany International under the trade designation Formtech™-6 moving at 214 feet per minute. The coform nonwoven web contains 50% by weight pulp (Golden Isles 4824, available from Georgia-Pacific) and 50 % by weight polypropylene (PF-015 available from Basell) and wherein the polypropylene filaments have an average fiber diameter of about 4 microns. The polypropylene was meltblown at a rate of about four (4) pounds per inch per hour, through each die and each die has 30 orifices per inch and having an average orifice diameter of about 0.0145 inches, at a primary air temperature of 515° F., using a primary air flow rates of about 330 cfm (cubic feet per minute). A vacuum was used below the wire to drawn the meltblown and pulp fibers into the wire. The resulting coform nonwoven fabric has a basis weight of about 70 gsm and about 48 tufts per square inch having a height of about 2.34 mm. This tufted nonwoven web is useful as a wiper.

FIG. 6A shows a topographical micrograph of this tufted nonwoven web and FIG. 6B shows a cross-section of this tufted nonwoven web.

### Comparative Example 1

The process conditions of Example 1 were repeated except the forming wire was replaced with an anti-stat polyester 14×14 forming surface. The resulting coform nonwoven web was bonded with a sine wave bond pattern with a bond area of about 11.7% and had a basis weight of about 68 gsm and a bulk of about 1.29 mm.

### Example 2

The conditions of Example 1 were repeated except that the forming wire was running at a speed of about 145 feet per minute. The resulting coform nonwoven fabric has a basis weight of about 106 gsm and about 48 tufts per square inch having a bulk of about 2.64 mm. This tufted nonwoven web is useful as a pre-saturated mop.

### Example 3

The material of Example 2 was pattern bonded using a heated hydraulic press having a plate engraved with a sine wave pattern. The bond area of the sine wave pattern is about 11.7% of the area. Both the top plate and the bottom plate are heated to a temperature of 165° F. (74° C.) and a pressure of about 3000 psi is applied to the material for about 1 minute.

### Comparative Example 2

The process conditions of Example 1 were repeated except the forming wire was replaced with a an anti-stat polyester 14×14 mesh forming surface and a layer of 14 gsm polypropylene spunbond was first placed on the forming surface. The resulting coform nonwoven web was bonded with a sine wave bond pattern (with a bond area of about 11.7% and had a basis weight of about 118 gsm and a bulk of about 2.02 mm.

### Example 4

Using the process described in FIG. 3, a tufted coform nonwoven web was formed on a forming wire available from Albany International under the trade designation Formtech™-6 moving at 20 feet per minute. The coform nonwoven web contains 30% by weight pulp (Golden Isles 4824, available from Georgia-Pacific) and 70% by weight of a mixture containing 90 % by weight polypropylene (PF-015 available from Basell) and 10% by weight polybutylene (Basell DP-891 1) wherein the meltblown filaments have an average fiber diameter of about 4 microns. The mixture was meltblown at a rate of about 1.5 pounds per inch per hour, through each die having 30 orifices per inch and having an average orifice diameter of about 0.0145 inches, at a primary air temperature of 435° F., using a primary air flow rates of about 330 cfm (cubic feet per minute). A vacuum was used below the wire to drawn the meltblown and pulp fibers into the wire. The resulting coform nonwoven fabric has a basis weight of about 200 gsm and about 48 tufts per square inch having a bulk of about 3.71 mm. This tufted nonwoven web is useful as an absorbent mop.

### Example 5

Using the process described in FIG. 4, a tufted coform nonwoven web was formed on a forming wire available from Albany International under the trade designation Formtech™-6 moving at 158 feet per minute. A first layer of coform is a fine coform layer comprises 40% by weight pulp (Golden Isles 4824, available from Georgia-Pacific) and 60% by weight polypropylene (PF-015 available from Basell) and has a fine fiber diameter of about 4 microns. The polypropylene was meltblown at a rate of about 9.6 pounds per inch per hour, through a die having 30 orifices per inch and having an average orifice diameter of about 0.0145 inches, at a primary air temperature of 515° F., using a primary air flow rates of about 330 cfm (cubic feet per minute) A second coform layer comprising 50% by weight pulp (Golden Isles 4824, available from Georgia-Pacific) and 50% by weight polypropylene (PF-015 available from Basell) is then formed on the first coform layer. The polypropylene for the second layer was meltblown at a rate of about eight (8) pounds per inch per hour, through a die having 30 orifices per inch an having an average orifice diameter of about 0.0145 inches, at a primary air temperature of about 5100 F, using a primary air flow rates of about 300 cfm. The resulting tufted coform nonwoven fabric has a basis weight of about 200 gsm and a bulk of about 3.85 mm.

Using a Gardner Wet Abrasion Scrub Tester (Cat. No. 5000), the ability of the tufted coform material of the present invention to clean a surface is compared to the material of Comparative Examples 1 and 2. The Tester was modified by removing the brushes and filling the cavities with LUCITE® blocks. Clamps held 2.25 in. (5.7 cm) by 8 in. (20.3 cm) samples of each material to the sleds of the Tester. A pressure of about 0.10 psi (3.9 g/cm²) was applied to each wipe as it is passed across the food stain.

Chocolate pudding was placed on white Delrin® polyacetal resin sheets. The pudding was placed on a template next to a hole in the template having a 0.25 inch diameter. The template was firmly pressed against the plastic panel, and the pudding was scraped over the hole using a spatula. Good contact between the spatula and template was maintained to get a uniform surface of pudding that was flush with the template upper surface. This process was repeated several times to ensure that no voids or irregularities were present. The pudding was allowed to dry overnight for approximately 15 hours. The resulting pudding stain had a diameter of about 0.25 inches and a thickness of about 0.016 inches.

The wipers of Examples 1 and 2 and Comparative Examples 1, 2 and 3 were saturated with a commercially available floor cleaner. The wipers of Examples 4 and 5 were tested by placing a ¼ tablespoon of a floor cleaner applied to the stain.

The panels having the dried pudding stain were placed into the Tester. The sled was allowed to pass back and forth over the stain until the stain was no longer visible. The number of cycles (back and forth motion) required to remove the stain was recorded. This test was repeated for 10 times and the results are shown in Table 1.

In addition, the capacity of each sample to absorb liquids was also tested. The results are also shown in Table 1 below.

TABLE 1

| Example | Basis Weight | Bulk | Capacity | Scrubbing (cycles) |
|---|---|---|---|---|
| 1 | 70 gsm | 2.34 mm | 11.4 g/g | 6.0 |
| Comp. 1 | 68 gsm | 1.29 mm | 9.7 g/g | 6.1 |
| 2 | 106 gsm | 2.64 mm | 10.3 g/g | 5.8 |
| 3 | 106 gsm | — | 10.1 g/g | 5.3 |
| Comp. 2 | 118 gsm | 2.02 mm | 8.6 g/g | 6.2 |
| 4 | 200 gsm | 3.71 mm | 9.2 g/g | 5.4 |
| 5 | 200 gsm | 3.85 mm | 10.9 g/g | 5.0 |

While the invention has been described in detail with respect to specific embodiments thereof, and particularly by the example described herein, it will be apparent to those skilled in the art that various alterations, modifications and other changes may be made without departing from the spirit and scope of the present invention. It is therefore intended that all such modifications, alterations and other changes be encompassed by the claims.

We claim:

1. A tufted coform nonwoven web comprising a matrix of thermoplastic meltblown filaments and at least one secondary material, wherein the coform nonwoven web has a first exterior surface comprises tufts, each tuft comprising a matrix of the thermoplastic meltblown filaments and the at least one secondary material.

2. The tufted coform of claim 1, wherein the secondary material comprises an absorbent material selected from the group consisting of absorbent particles, absorbent fibers and a mixture of absorbent fibers and absorbent particles.

3. The tufted coform of claim 2, wherein the absorbent material comprises pulp.

4. The tufted coform of claim 2, wherein the absorbent material comprises between about 15% and about 85% by weight of the coform material.

5. The tufted coform of claim 4, wherein the absorbent material comprises between about 20% and about 50% by weight of the coform material.

6. The tufted coform of claim 5, wherein the absorbent material comprises pulp.

7. The tufted coform of claim 6, wherein the thermoplastic meltblown filaments comprise polypropylene.

8. The tufted coform of claim 1, wherein the thermoplastic meltblown filaments comprise a polymer selected from the group consisting of polyolefins, polyesters, polyamides, polycarbonates, polyurethanes, polyvinylchloride, polytetrafluoroethylene, polystyrene, polyethylene terephthalate, polylactic acid and copolymers and blends thereof.

9. The tufted coform of claim 8, wherein the thermoplastic meltblown filaments comprise a polyolefin selected from the group consisting of polyethylene, polypropylene, polybutylene and blends thereof.

10. The tufted coform of claim 9, wherein the thermoplastic meltblown filaments comprise polypropylene.

11. The tufted coform of claim 10, wherein the thermoplastic meltblown filaments further comprise polybutylene and the polybutylene is present in an amount from about 0.1 to about 20% by weight of the thermoplastic filaments.

12. The tufted coform of claim 1, wherein the tufts have a height between about 0.1 mm and about 25 mm.

13. The tufted coform of claim 12, wherein the tufts have a height between about 0.5 mm and about 10 mm.

14. The tufted coform of claim 1, wherein there are between 1 and about 100 tufts per square inch of the coform nonwoven web.

15. The tufted coform of claim 14, wherein there are between 10 and 50 tufts per square inch of the coform nonwoven web.

16. The tufted coform of claim 1, wherein the secondary material comprises an absorbent material selected from the group consisting of absorbent particles, absorbent fibers and a mixture of absorbent fibers and absorbent particles; the absorbent material comprises between about 15% and about 85% by weight of the coform material; the thermoplastic meltblown filaments comprise a polymer selected from the group consisting of polyolefins, polyesters, polyamides, polycarbonates, polyurethanes, polyvinylchloride, polytetrafluoroethylene, polystyrene, polyethylene terephthalate, polylactic acid and copolymers and blends thereof; the tufts have a height between about 0.1 mm and about 25 mm, and there are between 1 and about 100 tufts per square inch of the coform nonwoven web.

17. The tufted coform of claim 16, wherein the absorbent material comprises pulp, the pulp comprises between about 20% and about 50% by weight of the coform material, the meltblown filament comprise polypropylene, the tufts have a height between about 0.3 mm and about 5 mm, and there are between 10 and about 50 tufts per square inch of the coform nonwoven web.

18. The tufted coform of claim 1, comprising a single layer of coform.

19. The tufted coform of claim 1, comprising at least two layers of coform.

20. The tufted coform of claim 1, wherein the tufted coform further pattern bonded.

21. The tufted coform of claim 20, wherein the bond patter is a sine-wave bond pattern.

22. A wiper comprising the tufted coform nonwoven web of claim 1.

23. The wiper of claim 22, wherein the wiper is saturated with between about 150 and about 900 weight percent of a liquid, based on the dry weight of the wiper.

24. A wiper comprising the tufted coform nonwoven web of claim 17.

25. A mop comprising the tufted coform nonwoven web of claim 1.

26. The mop of claim 24, wherein the mop is saturated with between about 500 and about 900 weight percent of a liquid, based on the dry weight of the mop.

27. A mop comprising the tufted coform nonwoven web of claim 17.

28. A cleaning implement comprising:
a. a handle;
b. a head; and
c. a removable cleaning sheet;
wherein head is connected to the handle, the removable cleaning sheet is removable attached to the head and the removable cleaning sheet comprises the tufted coform nonwoven web of claim 1.

29. A cleaning implement comprising:
a. a handle;
b. a head; and
c. a removable cleaning sheet;
wherein head is connected to the handle, the removable cleaning sheet is removable attached to the head and the removable cleaning sheet comprises the tufted coform nonwoven web of claim 17.

30. A method of cleaning a surface comprising contacting and wiping the surface with a cleaning sheet comprising the tufted coform nonwoven web of claim 1.

31. A method of cleaning a surface comprising contacting and wiping the surface with a cleaning sheet comprising the tufted coform nonwoven web of claim 17.

32. A kit comprising the cleaning implement of claim 28 and a plurality of the tufted coform nonwoven webs.

33. A kit comprising the cleaning implement of claim 29 and a plurality of the dual texture nonwoven webs.

34. A method of preparing a three-dimensional tufted coform nonwoven web comprising:
a. providing at least one stream comprising meltblown filaments;
b. providing at least one stream comprising at least one secondary material;
c. converging the at least one stream containing at least one secondary material with the at least one stream of meltblown filaments to form a composite stream;
d. depositing the composite stream onto a shaped forming surface as a matrix of meltblown filaments and at least one secondary material to form a first deposited layer;
e. optionally applying a pressure differential to the matrix while on the forming surface; and
f. separating the nonwoven web from the shaped forming surface, wherein the nonwoven web comprises an array of projections and land areas corresponding to the shaped forming surface.

35. The method of claim 34, further comprising
d1. providing a second stream of meltblown filaments
d2. introducing a stream at least one secondary material to the second stream of meltblown filaments to form a second composite stream;
d3. depositing the second composite stream onto the deposited layer as a matrix of meltblown filaments and a secondary material to for a two layer tufted coform nonwoven web.

36. The method of claim 33, wherein the forming surface comprises an open area between about 35% and 65% of the forming surface and a differential pressure is applied to the matrix while the matrix is on the forming surface.
